(19) United States
(12) Patent Application Publication
(10) Pub. No.: US 2006/0011589 A1
(43) Pub. Date: Jan. 19, 2006

(54) Production of a circuit-breaker pole, insulated by a solid material

(75) Inventors: Uwe Hering, Berlin (DE); Ralf-Reiner Volkmar, Berlin (DE)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munchen (DE)

(21) Appl. No.: 10/532,121

(22) PCT Filed: Oct. 7, 2003
(86) PCT No.: PCT/DE03/03362

§ 371 Date: Apr. 20, 2005

(30) Foreign Application Priority Data
Oct. 21, 2002 (DE) 102 49 615.3

(51) Int. Cl. H01H 33/66

(52) U.S. Cl. 218/118

(57) ABSTRACT

The invention relates to a method for producing a circuit-breaker pole (1), insulated by a solid material, said pole comprising an actuator opening that is configured to introduce an actuation displacement. According to said method: a switch (2) comprising a switch housing (3), which has an actuation face (8), through which a drive rod (9) is guided and a dimensionally stable jacket (7) consisting of insulation material and provided with a connection part (6) are produced independently of one another; the switch (2) is fixed in the jacket (7) in such a way that the switch housing (3) excluding the actuation face (8) and the jacket (7) that is provided with the connecting part (6) delimit a gap which opens towards the actuation opening; the gap is subsequently filled with a fluidic compensating mass (10) and finally said mass (10) is cured. The invention also relates to a circuit-breaker pole (1) comprising a potting channel, for interrupting an electric current.

### CLAIM FOR PRIORITY

This application is a national stage of PCT/DE2003/003362, published in the German language on May 6, 2004, which claims the benefit of priority to German Application No. 102 49 615.3, filed on Oct. 21, 2002.

### TECHNICAL FIELD OF THE INVENTION

The invention relates to a method for producing a breaker pole with solid-material insulation and having at least one drive opening which is provided for the purpose of introducing a drive movement, and to a breaker pole with solid-material insulation for interrupting an electrical current having a drive opening.

### BACKGROUND OF THE INVENTION

A method and breaker pole are disclosed in German Application DE 197 12 182 A1. In accordance with the previously known method, a vacuum-operated breaker having a vacuum housing is produced. The vacuum housing is made of a hollow-cylindrical ceramic section which is sealed in a gas-tight manner by end-side metal walls. A fixed contact and, axially opposite this, a moving contact are arranged in the interior of the vacuum housing, the fixed contact being fixedly connected to one of the end-side metal walls. The moving contact is held by a switching rod which passes through the end-side metal wall, remote from the fixed contact, and which is provided for the purpose of introducing a drive movement of a drive unit.

For producing the solid-material insulation of the breaker pole, a shrink sleeve which is made of an elastic rubber is pushed over the breaker which is provided with connection parts. In this case, the shrink sleeve is held in a cylindrical shape by plastic helices which makes it easier to push it over the cylindrical vacuum housing. Once the plastic helices have been removed, the sleeve, which is made of ethylene-propylene-diene rubber, is positioned evenly on the vacuum housing. Once the rubber has been applied, the vacuum-operated breaker is encapsulated by aromatic or cycloaliphatic, filled epoxy resins using conventional pressure-gel methods, the rubber serving to seal the casting mold to form the mold core. The shrink sleeve acts as a compensating compound for the purpose of compensating for temperature-dependent volume expansions of the breaker, which may lead to undesirable cracks in the solid-material insulation.

The abovementioned method has the disadvantage that the solid-material insulation cannot be produced independently of a breaker. Once the breaker is complete, the breaker therefore needs to be transported in a laborious manner to the production site of the solid-material insulation. This is particularly disadvantageous when the production of the solid-material insulation is the responsibility of a supplier. In this case, the breaker generally needs to first be transported to the supplier and then back again to the breaker manufacturer with the solid-material sheath.

### SUMMARY OF THE INVENTION

The invention relates to a method for producing a breaker pole with solid-material insulation and having at least one drive opening which is provided for introducing a drive movement.

The invention also relates to a breaker pole with solid-material insulation for interrupting an electrical current having a drive opening which is provided for introducing a drive movement, a breaker, which has a breaker housing, and a sheath, which is made of an insulating material, is provided with a connection part and in which the breaker is fixed, an intermediate space formed between the sheath and the breaker housing being filled up by a compensating compound such that the breaker housing is at least partially surrounded by the compensating compound.

The invention therefore provides a method of the type mentioned initially with which transportation of the breaker to the production site of the solid-material sheath is avoided.

The invention also provides a breaker pole with solid-material insulation of the type mentioned initially which is cost-effective.

In one embodiment of the invention, there is a method for producing a breaker pole with solid-material insulation and having a drive opening which is provided for introducing a drive movement, in the case of which a breaker having a switching housing, which has a drive side through which a switching rod passes, and a dimensionally stable sheath, which is made from insulating material and is provided with a connection part, are produced independently of one another, in the case of which the breaker is fixed in the sheath such that the breaker housing (with the exception of the drive side) and the sheath provided with the connection part delimit an intermediate space which is open towards the drive opening, in the case of which the intermediate space is then filled with a fluid compensating compound, and finally the compensating compound cures.

In another embodiment of the invention, the breaker pole mentioned has a casting channel provided in the sheath, which is provided with the connection part, for producing the compensating compound once the breaker has been assembled.

According to another embodiment of the invention, the dimensionally stable sheath and the breaker to be insulated can be produced independently of one another. Once production of the components has been completed separately is the breaker fixed in the sheath. In this case, a connection part may already be fixed to the sheath, and this connection part serves the purpose of electrically connecting the entire component during operation of the breaker pole. As an alternative to this, it is possible in accordance with the invention not to fix the connection part to the sheath until the breaker is assembled. The breaker housing (with the exception of the drive side), the connection part and the sheath should be dimensioned so as to fit together such that they delimit an intermediate space which adjoins the entire breaker housing (with the exception of the drive side). This intermediate space may now be filled with the compensating compound in a simple manner, for example by supplying a sleeve which protrudes into the intermediate space. According to the invention, even a breaker which has a moveable switching rod passing through it can be cushioned in this way without the drive movement of the switching rod being impaired. For this purpose, sufficient fluid compensating compound should be fed into the intermediate space for at least the switching rod to remain free of compensating compound. The intermediate space should therefore be filled to such an extent that it is not overfilled or is overfilled only slightly, with the result that fluid compensating compound emerging from the intermediate space runs on the path towards the switching rod and does not cure at the switching rod. However, it is also possible in accordance with the invention to protect the switching rod against compensating compound emerging from the intermediate space during or after filling with the aid of a shaped collar. In place of a drive rod, which generally carries out a stroke movement, according to the invention a rotatable switching shaft can also be used for the purpose of introducing the drive movement into the switching housing.

In the context of the invention, fluid is understood to mean that the compensating compound has such a viscosity, at least prior to curing and at the selected production temperature, that it at least partially fills up the intermediate space once it has been fed into the intermediate space by means of flow processes. The more fluid the compensating compound is, the quicker the production process. However, feeding of the fluid compensating compound must take place slowly and carefully enough for air or gas pockets to largely be prevented. Since the intermediate space is open, the gas which is displaced when the intermediate space is filled can emerge via the drive opening of the breaker pole towards the outside atmosphere.

Elastomers are advantageously used as the compensating compound whose polymerization or cross-linking is not yet complete. In the context of the invention, it is naturally also possible for expedient monomers to be fed into the intermediate space and for polymerization to then be started by suitable chemical or physical initiators. A suitable elastomer is, for example, polyurethane. In one preferred exemplary embodiment, the compensating compound is a rubber, in particular silicone rubber. In the context of the invention, it is also possible to use ethylene-propylene-diene rubber (EPDM). However, EPDM is fed into the intermediate space at higher temperatures, for example by means of an injection molding process. The compensating compound advantageously has good thermal conductance.

Suitable insulating materials for producing the dimensionally stable sheath are nonconductive thermoplasts or duroplasts and, in particular resins, such as epoxy resins.

In one preferred exemplary embodiment of the invention, the intermediate space is filled with the fluid compensating compound via at least one casting channel provided in the sheath and/or the connection part. When the intermediate space is filled via a casting channel, gases found in the intermediate space, such as air, can be displaced uniformly by the compensating compound. Air pockets in the cushioning comprising the compensating compound are then prevented with a reduction in the resistance to leakage currents and in the dielectric strength. The casting channel(s) expediently have small dimensions in comparison to the intermediate space.

In one exemplary embodiment of concern here, a single casting channel is provided in the connection part, which is produced so as to be electrically conductive and is therefore produced from a metal. The connection part therefore has a mechanical strength which is greater than that of the sheath. Tubes or sleeves which are provided for the purpose of supplying the fluid compensating compound may thus be fixed in a simple manner, for example by providing an expedient thread, to the metallic wall of the casting channel. A directional valve, for example, can thus be screwed onto the connection part, and this directional valve allows the passage of a fluid only in one direction. The use of a compression valve is also possible in accordance with the invention.

As a deviation from this, a casting channel may be provided only in the sheath. Furthermore, it is possible in the context of the invention for casting channels to be provided both in the sheath and in the connection part, the sections of each casting channel which are introduced into the respective components opening out into one another such that the intermediate space can be filled from the outside.

Furthermore, it is preferable if each casting channel is arranged below the intermediate space when it is filled with the fluid compensating compound. The risk of undesirable air pockets, which would reduce the dielectric strength of the solid-material insulation, is thus reduced further still. With this refinement, the fluid compensating compound can displace the air continuously out of the intermediate space as it rises slowly from the bottom to the top.

In the case of another embodiment of the invention, a vacuum is produced in the intermediate space when it is filled with the fluid compensating compound. On the one hand, the vacuum accelerates the filling process and, on the other hand, also serves the purpose of reducing the risk of air pockets.

It may furthermore be preferable to introduce the fluid compensating compound into the intermediate space under pressure. The fluid compensating compound may, for this purpose, be supplied to the intermediate space via suitable tubes or sleeves. Owing to the excess pressure during feeding, the transportation speed of the fluid is increased within this supplying tube system, with the result that the production process is thus accelerated.

In one embodiment of the invention, each casting channel is sealed after filling. The seal may be a simple screw which is screwed into a thread, for example after filling, in place of a valve, this thread having been introduced into the wall of the casting channel.

As a deviation from this, each casting channel is sealed with an insulating material.

The connection part is advantageously cast into the sheath when the latter is produced. Owing to this interlocking connection, the connection part does not need to be fixed in a complex manner in the dimensionally stable sheath, for example by screwing, adhesion or the like.

### BRIEF DESCRIPTION OF THE DRAWINGS

The invention is further described below using exemplary embodiments of the invention with reference to the figures in the drawings, in which corresponding components are provided with identical reference numerals and in which:

FIG. 1 shows a longitudinally sectioned view of an exemplary embodiment of a breaker pole with solid-material insulation.

FIG. 2 shows a longitudinal section view of a further exemplary embodiment of the breaker pole with solid-material insulation according to the invention.

### DETAILED DESCRIPTION OF THE INVENTION

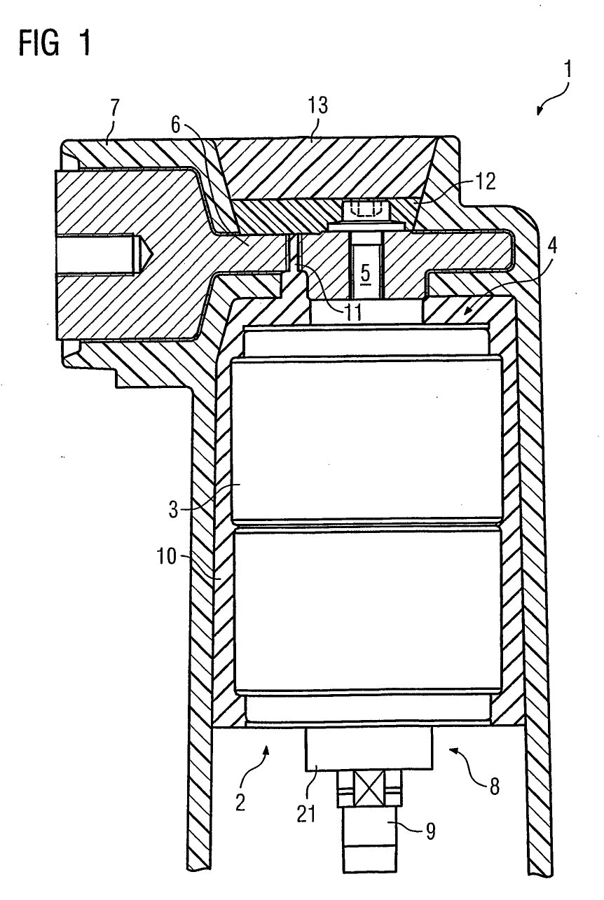

FIG. 1 shows a longitudinal section view of an exemplary embodiment of the breaker pole 1 according to the invention. The breaker pole 1 illustrated has, as the breaker, a vacuum-operated breaker 2 having a breaker housing 3. The breaker housing 3 is fixedly connected to a connection part 6 at a fixing side 4 by means of a screw connection 5, the connection part 6 being provided for the purpose of connecting the breaker pole 1 to a current-carrying conductor (not shown). In this case, the connection part 6 is connected in an interlocking manner to a sheath 7, which is designed to be dimensionally stable or, in other words, rigid, in order to provide the mechanical strength required for holding the vacuum-operated breaker 2. An insulating material which meets these requirements is, for example, an aromatic or cycloaliphatic epoxy resin. In the exemplary embodiment shown, the sheath 7 is made of cast resin. It can also be seen clearly from FIG. 1 that the breaker pole 1 forms an encapsulated end side by means of the connection part 6 and the sheath which is connected in an interlocking manner to the connection part 6. At its end side which is opposite the connection part 6, the breaker pole 1 has a drive opening, by means of which it is possible to introduce a drive movement.

The vacuum-operated breaker 2 is provided with a drive side 8, which faces the drive opening and which has a switching rod 9 passing through it. The switching rod 9 is sealed off with respect to the breaker housing 3 by means of metal bellows (not shown), with the result that a stroke movement of the switching rod 9 is made possible. Owing to this stroke movement, a moving contact which is likewise arranged within the breaker housing 3 is brought into contact with a fixed contact. In this contact position, it is now possible for current to be conducted via the vacuum-operated breaker 2. The switching rod 9 is part of a drive linkage which is passed out of the breaker pole 1 via the drive opening to a drive module arranged outside the breaker pole 1.

The vacuum-tight breaker housing 3 is usually made from a tubular ceramic, which is sealed tight both at the fixing side 4 and at the drive side 8 by metallic cover plates. Different thermal expansions of this composite body may lead to stresses in the dimensionally stable sheath 7 made of cast resin and, furthermore, even in their destruction. In order to counterbalance these thermally induced expansions, a compensating compound 10 is provided between the sheath 7 and the breaker housing 3. The vacuum-operated breaker 2 is therefore completely surrounded (with the exception of its drive side 8) by an insulating solid.

In the exemplary embodiment shown, a casting channel 11 is provided in the connection part 6 for introducing the compensating compound 10, the connection part 6 being electrically insulated with respect to the outside at its side which is remote from the vacuum-operated breaker 2 by means of an elastomer 12, for example silicone rubber, and a further dimensionally stable plastic 13, for example cast resin.

In order to produce the breaker pole 1, initially the vacuum-operated breaker 2 is produced. Independently of this, the sheath 7 which is provided with the connection part 6 is produced, in this case the connection part 6 having been cast into the insulating material of the sheath 7. The vacuum-operated breaker 2 can now be fixedly connected at its fixing side 4 to the connection part 6 and thus to the entire sheath 7 by means of the screw connection 5. The fluid compensating compound 10 is supplied via the casting channel 11, which has a thread in the exemplary embodiment shown into which a directional valve (not shown) which is provided with a sleeve is screwed. In the exemplary embodiment shown, the fluid compensating compound 10 is likewise made of silicone rubber, which, however, has not been completely cured or in other words has not been completely cross-linked and thus has a sufficiently low viscosity to flow via the sleeve connection through the valve and the casting channel 11 into the intermediate space.

When the fluid compensating compound 10 is fed, the breaker pole 1 is expediently aligned in the reverse position to that shown in FIG. 1 such that the casting channel 11 is located below the intermediate space and the fluid compensating compound 10 rises from the bottom to the top, counter to the force of gravity. The air which is located in the intermediate space is thus displaced slowly from the bottom to the top. In order to accelerate the described filling process and to further reduce the risk of air pockets, the sheath 7 can be sealed at its drive opening, and a slight vacuum can be applied in the cavity produced. In order to prevent curing of the compensating compound 10 at the switching rod 9, in principle only sufficient fluid compensating compound 10 should be fed for the intermediate space to be almost completely filled. In any case, slight overfilling is possible such that the excess amount of compensating compound 10 runs on the drive side 8 of the vacuum-operated breaker 2. In the exemplary embodiment illustrated, however, a shaped collar 21 is provided for the purpose of protecting the switching rod 9 against curing compensating compound 10. With the aid of the shaped collar, large parts of the drive side 8 can now as a result be embedded in the compensating compound 10.

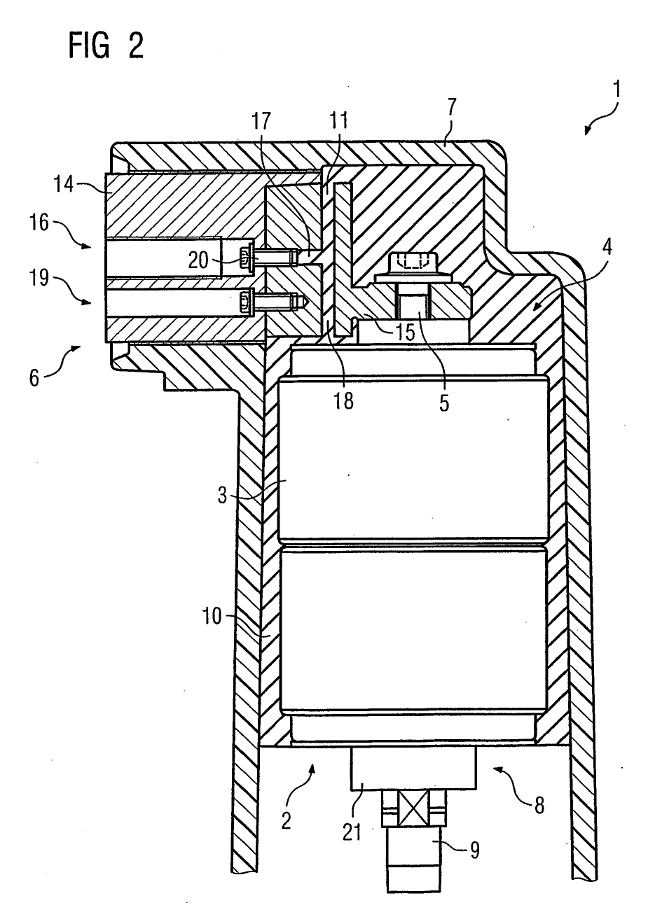

FIG. 2 shows a further exemplary embodiment of the breaker pole 1 according to the invention. The connection part 6 shown here is of two-part design and comprises a mouthpiece 14, which is passed out at the end of the sheath 7 and a fixing piece 15 which is connected to the vacuum- operated breaker 2 by means of the screw connection 5. In the exemplary embodiment shown, the casting channel 11 is in the form of a T and has an outer channel 17, which opens out into a connection opening 16, and an inner channel 18 which runs at right angles to the outer channel 17. In addition, a fixing opening 19 can be seen in the mouthpiece 14.

The production of the breaker pole 1 shown again takes place initially by independent production of the sheath 7 and the vacuum-operated breaker 2, the sheath 7 not being produced with the entire connection piece 6 but merely together with the mouthpiece 14 by the latter being cast in cast resin. The fixing piece 15 is mounted on the vacuum-operated breaker 2 by means of the screw connection 5. Then, the components which are connected to one another are introduced into the cavity in the sheath 7. The vacuum-operated breaker 2 is fixed to the sheath 7 by means of the screw connection arranged in the fixing opening 19. Once the vacuum-operated breaker 2 has been fixed, the fluid compensating compound 10 is supplied. For this purpose, an expedient tube or sleeve connection is fixed to the outer channel 17 of the casting channel 11, for example, by means of a thread, the connection opening 16 providing the necessary access from the outside. The fluid compensating compound 10 is then pumped via the outer channel 17 and the inner channel 18 into the intermediate space. As in the case of the previous exemplary embodiment, the breaker pole 1 can be filled up from the bottom to the top until the filling level provided for the intermediate space is reached. In addition, a vacuum can be applied in the intermediate space.

After feeding of the compensating compound 10, the casting channel 11 is sealed by means of a sealing screw 20.

1. A method for producing a breaker pole with solid-material insulation, comprising:
providing a drive opening for introducing a drive movement;
producing, independently from one another, when the breaker has a switching housing, which has a drive side through which a switching rod passes, and a dimensionally stable sheath, which is made from insulating material and is provided with a connection part;
when the breaker is fixed in the sheath such that the breaker housing, with the exception of the drive side, and the sheath provided with the connection part delimit an intermediate space which is open towards the drive opening, the intermediate space being filled with a fluid compensating compound; and
curing the compensating compound.

2. The method as claimed in claim 1, wherein the intermediate space is filled with the fluid compensating compound via at least one casting channel provided in the sheath and/or the connection part.

3. The method as claimed in claim 2, wherein each casting channel is arranged below the intermediate space when it is filled with the fluid compensating compound.

4. The method as claimed in claim 1, wherein a vacuum is applied in the intermediate space when it is filled with the fluid compensating compound.

5. The method as claimed claim 1, wherein the fluid compensating compound is introduced into the intermediate space under pressure.

6. The method as claimed in claim 2, wherein each casting channel is sealed after filling.

7. The method as claimed in claim 6, wherein each casting channel is sealed with an insulating material.

8. The method as claimed in claim 1, wherein the connection part is cast into the sheath when the latter is produced.

9. A breaker pole with solid-material insulation for interrupting an electrical current, comprising:
a drive opening which is provided for introducing a drive movement;
a breaker, which has a breaker housing;
a sheath, which is made of an insulating material, provided with a connection part and in which the breaker is fixed, an intermediate space formed between the sheath and the breaker housing being filled up by a compensating compound such that the breaker housing is at least partially surrounded by the compensating compound; and
a casting channel is provided in the sheath, which is provided with the connection part for producing the compensating compound once the breaker has been assembled in the sheath which is provided with the connection part.
